(19) United States
(12) Patent Application Publication
(10) Pub. No.: US 2025/0322729 A1
(43) Pub. Date: Oct. 16, 2025

(54) TECHNOLOGICAL FRAMEWORK FOR A DYNAMIC VIRTUAL CARD DECK SYSTEM

(71) Applicant: Philip Paul Givant, Carmichael, CA (US)

(72) Inventor: Philip Paul Givant, Carmichael, CA (US)

(21) Appl. No.: 19/252,727

(22) Filed: Jun. 27, 2025

Related U.S. Application Data
(63) Continuation-in-part of application No. 19/182,360, filed on Apr. 17, 2025.
Application No. 19/182,360 is a continuation-in-part of application No. 17/956,583, filed on Sep. 29, 2022, now Pat. No. 12,400,524.
Application No. 17/956,583 is a continuation-in-part of application No. 17/588,329, filed on Jan. 30, 2022, now Pat. No. 11,861,987.
Application No. 17/588,329 is a continuation of application No. 16/665,684, filed on Oct. 28, 2019, now Pat. No. 11,270,556.
Application No. 16/665,684 is a continuation of application No. 15/437,125, filed on Feb. 20, 2017, now Pat. No. 10,460,568.
Application No. 15/437,125 is a continuation of application No. 14/981,408, filed on Dec. 28, 2015, now Pat. No. 9,589,418.
Application No. 14/981,408 is a continuation-in-part of application No. 14/684,160, filed on Apr. 10, 2015, now abandoned.
Application No. 14/684,160 is a continuation-in-part of application No. 13/945,628, filed on Jul. 18, 2013, now abandoned.
(60) Provisional application No. 61/741,463, filed on Jul. 19, 2012.

(51) Int. Cl. G07F 17/32

(52) U.S. Cl. CPC G07F 17/3288; G07F 17/3209; G07F 17/3213; G07F 17/3223; G07F 17/3227; G07F 17/323; G07F 17/3237; G07F 17/3239; G07F 17/3258; G07F 17/3276

(57) ABSTRACT

An interactive computer-implemented system manages a virtual deck of digital cards whose attributes, such as value, status, score, or color, refresh continuously in response to live external data. A server-side ingestion pipeline normalizes event feeds and maps them to a programmable card object model executed on one or more processors. A rendering engine delivers sub-five-second visual updates, while a synchronization layer broadcasts state changes to all connected clients to maintain uniform gameplay. A rules-based constraint engine recalculates permissible user actions as card states evolve, preventing pre-event optimization and preserving competitive fairness. The architecture is device-agnostic, supports accessibility overlays, and extends beyond fantasy sports to any domain where real-time data drives interactive visual objects.

### REFERENCE TO PRIORITY PATENT APPLICATIONS

The present application is a continuation-in-part (CIP) application of U.S. application Ser. No. 19/182,360, filed Apr. 17, 2025; which is a continuation-in-part (CIP) application of U.S. application Ser. No. 17/956,583, filed Sep. 29, 2022; which is a continuation-in-part (CIP) application of U.S. application Ser. No. 17/588,329, filed Jan. 30, 2022; which is a continuation application of U.S. application Ser. No. 16/665,684, filed Oct. 28, 2019, now U.S. Pat. No. 11,270,556; which is a continuation application of U.S. application Ser. No. 15/437,125, filed Feb. 20, 2017, now U.S. Pat. No. 10,460,568; which is a continuation application of U.S. application Ser. No. 14/981,408, filed Dec. 28, 2015, now U.S. Pat. No. 9,589,418; which is a non-provisional continuation-in-part patent application claiming priority to application Ser. No. 14/684,160, filed on Apr. 10, 2015; which is a non-provisional continuation-in-part patent application claiming priority to application Ser. No. 13/945,628, filed on Jul. 18, 2013; which is a non-provisional patent application claiming priority to Ser. No. 61/741,463, filed on Jul. 19, 2012. The present patent application claims priority to the referenced patent applications, which are hereby incorporated by reference herein in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2012-2025, Philip Paul Givant, All Rights Reserved.

### TECHNICAL FIELD

The present invention relates to computer-based systems for managing dynamic virtual card objects, specifically designed to provide real-time updates to the properties of these cards based on live external data. The invention enhances the interactivity and responsiveness of the virtual card system without altering the fundamental rules or format of existing card games. Although applicable to gaming and fantasy sports, the invention is broadly relevant to any domain where live data must dynamically influence distributed interactive objects, including finance, education, meteorology, and political simulations.

### BACKGROUND

Conventional card games and data dashboards, whether physical or digital, rely on static representations of value, color, and state. Fantasy sports implementations, for example, typically render live data separately from the game interface, without integrating real-time updates into individual interactive elements. Existing fantasy sports systems typically allow users to pre-select athletes from a narrow elite subset, enabling deterministic optimization strategies and diminishing the strategic relevance of the broader athlete pool. This separation limits engagement and reduces adaptability. Existing systems do not bind external live data directly to game elements or digital object states across a distributed architecture. As a result, they cannot provide dynamic updates to individual user-facing components in a consistent, synchronized, and accessible manner. Therefore, a technical framework is required to enable data ingestion, rendering, update propagation, and inclusive user interaction in real time.

A particularly acute technical problem in fantasy sports applications arises from the use of brute-force lineup generation and deterministic combinatorics. In current large-scale competitions, users can programmatically generate thousands of lineup permutations using only a narrow pool of high-value athletes. These permutations are submitted in bulk before any live events begin, enabling users to cover all possible favorable combinations. This undermines competitive fairness, reduces the value of the broader athlete pool, and turns the contest into a lottery dominated by volume and automation rather than skill. One widely publicized incident demonstrated this vulnerability when a DraftKings employee used internal data to identify undervalued star athletes, then submitted optimized lineups on a competing platform—resulting in a $350,000 win before eventual disqualification. This real-world case exemplifies the systemic failure of platforms to enforce technical fairness at the data architecture level.

Further highlighting the loophole in traditional lineup structures, some users have circumvented entry caps by teaming with others to collectively submit all possible athlete combinations. A 2020 investigation exposed a celebrity couple allegedly coordinating their entries to exceed the standard 150-lineup cap on a fantasy platform, raising red flags only because of their public visibility. Such coalition-based exploits are nearly impossible to detect or prevent without technical enforcement mechanisms, revealing a structural weakness in platforms that rely solely on entry limits and manual review. The ability to manipulate lineups through collaboration or statistical modeling underscores the inadequacy of current systems to ensure fair play through architecture alone.

The systemic nature of these vulnerabilities was further validated during a hearing before the Virginia Gaming Commission, where evidence was presented showing that even traditional lotteries—such as the Texas State Lottery—could be manipulated through mass combination entry strategies. Despite all numbers being mathematically equal, players seeking advantage could exploit public access and ticket purchasing structures to concentrate entries and gain statistical edge. The Commission's recognition of this vulnerability further supports the need for a real-time constraint framework capable of preventing both deterministic optimization and volume-based manipulation.

### SUMMARY

This invention provides a computer-implemented system for enforcing real-time, data-driven constraints in multiplayer fantasy sports competitions. The system introduces virtual card objects representing live athlete data, which dynamically update as external event data is ingested. Users interact with these cards during live sporting events, with their decision space limited by a real-time constraint enforcement engine that gates actions based on current athlete status and statistics. This prevents pre-event lineup optimization and eliminates deterministic outcome exploits. A synchronization layer ensures latency-controlled consistency across distributed clients. The system also incorporates multilingual rendering, symbolic overlays for accessibility, and interface adaptation across device types. These components work in tandem to deliver a fairness-preserving architecture that enforces gameplay integrity not through static rule sets, but through dynamic system behavior governed by real-time external data. While particularly applicable to fantasy sports, the invention extends to any domain requiring live data integration with constrained user interaction environments.

Existing systems rely on static or pre-determined game elements, where updates to game state are either predetermined or occur after the selection of participants. In contrast, the invention disclosed herein enables continuous, real-time updates to virtual card properties, allowing for a more dynamic and engaging user experience. It is important to note that the invention does not involve the creation of new gameplay rules, but instead, focuses on improving the technological framework by enabling real-time data-driven updates to virtual cards.

The exploits described above are not prevented by current fantasy platforms, which lack any technical enforcement layer that would constrain selection strategies or synchronize decision-making with the timing of real-world events. The present invention addresses this structural vulnerability through a platform that dynamically assigns athletes to players during the live event itself via virtual card objects. These digital cards update in real time as live data changes, and player decisions must be made through interaction with these evolving cards. This enforces a data-driven constraint system wherein athlete allocation is not selectable in advance and must be earned or revealed as part of an interactive real-time game layer. The invention thereby provides a technical solution to a fairness and integrity problem rooted in static pre-event optimization, transforming a known exploit in deterministic lineup construction into a latency-sensitive, data-integrated, and synchronized allocation framework. By embedding a real-time decision engine inside a live data stream, the invention creates a game-within-a-game structure that cannot be replicated without the disclosed architectural components.

The invention comprises a platform that dynamically modifies visual and status attributes of digital card objects based on real-time external data inputs. The system includes the following components:
A server-based data ingestion system configured to receive external event feeds.
A programmable card object model mapping normalized input data fields to card properties.
A rendering engine for latency-optimized visual updates.
A synchronization layer for real-time client consistency.
An accessibility engine for overlays, contrast modifications, and symbolic substitution.

The invention comprises a platform that dynamically modifies visual and status attributes of digital card objects based on real-time external data inputs. The system includes components such as a data ingestion engine, a programmable card object model, a rendering engine, and a synchronization layer. Importantly, the system does not modify traditional game rules or introduce new mechanics but focuses on the technical enhancement of virtual card attributes using live data streams.

### BRIEF DESCRIPTION OF THE DRAWINGS

The various embodiments are illustrated by way of example, and not by way of limitation, in the figures of the accompanying drawings in which:

FIG. 1 is a block diagram showing a system architecture of an example embodiment including ingestion, backend, and rendering components;

FIG. 2 is an example card layout with dynamic attributes (e.g., color, score, status);

FIG. 3 is a synchronization workflow for a multiplayer environment;

FIG. 4 illustrates visual variants of cards including contrast and symbol overlays;

FIG. 5 illustrates a WebSocket failover procedure with HTTP fallback; and

FIG. 6 is a behavior state machine for card objects in an example embodiment.

### DETAILED DESCRIPTION

### Technical Problem and Solution

The invention addresses the technical problem of integrating real-time external data into distributed, interactive interfaces while maintaining rendering accuracy, responsiveness, and accessibility. The solution comprises a modular architecture that includes a real-time data ingestion engine, a card object mapping model, a rendering pipeline, and a synchronization layer that broadcasts changes across all client sessions. These components function together to produce a technical effect: enabling real-time state changes in dynamic visual components synchronized across heterogeneous devices with visual accessibility enhancements.

The present invention addresses the technical limitations of existing systems where external data (such as sports statistics or financial metrics) are applied in a static manner or after the selection of participants. Unlike existing systems, which simply apply static data after selections are made, the invention disclosed herein integrates real-time data into a virtual card object model, where card attributes are continuously updated throughout the duration of the contest. This system creates a technical effect that enhances the game environment by providing real-time data integration and multi-client synchronization, while maintaining the game's established rules and format.

The invention disclosed herein provides a software-based system for managing dynamic digital object states through external event integration in a platform-agnostic and legally compliant framework. The system does not involve the creation of new game mechanics, strategies, or rules.

### Inventive Step Justification

Conventional systems do not incorporate mechanisms to dynamically reflect real-time external data changes in synchronized visual environments comprising card-like digital elements. While live sports data feeds have long been used to update fantasy team scores after team selection, the invention disclosed herein allows card-based gameplay to occur simultaneously with the sporting event, wherein dynamically updating cards determine team composition in real time. The system achieves a synergistic effect by solving latency, consistency, and accessibility problems simultaneously in a multi-client environment—representing a non-obvious inventive contribution over conventional architectures. This invention introduces a novel, non-obvious solution by integrating data ingestion, object mapping, dynamic rendering, and synchronization across clients. Features such as contrast-based accessibility overlays, symbolic replacement of color cues, dependency-aware rendering logic, and protocol failover mechanisms represent tangible technical improvements. The invention meets the criteria of inventive step by addressing a technical problem with a technical means that is not derivable from known art.

While prior systems have used live data feeds to update scores or game states, the invention disclosed herein introduces a novel and non-obvious approach by continuously updating the attributes of virtual cards in real time. The system integrates dynamic, data-driven changes to virtual card objects without altering the underlying game rules or formats. This technical solution provides an innovative method of using live data to change the properties of virtual cards, thus enabling a more engaging, interactive experience that does not require a modification of the established gameplay mechanics.

### Inventive Step Summary

The invention presents a novel computer-implemented architecture that allows real-time external data to directly drive the behavior, display, and interactivity of virtual card objects. By tightly integrating a data ingestion engine, programmable card object model, low-latency rendering engine, synchronization layer, and accessibility overlay system, the invention enables a dynamic gameplay environment that updates live in sync with real-world events. Unlike prior systems that display static or separate dashboards, this system creates a contest-within-a-contest: one where card-based interactions directly reflect live data while also determining how that data is used to build or modify game outcomes. This architecture addresses a technical problem with a non-obvious and technically integrated solution that enhances both system responsiveness and user inclusivity across heterogeneous clients.

In addition, the invention disclosed herein addresses the accessibility limitations of color-based card identification by integrating a symbolic overlay system. During testing, it was discovered that color-blind users were unable to differentiate between cards based solely on color. In response, the system was modified to associate each color with a unique symbol (e.g., a star for blue), which is rendered dynamically alongside or in place of color cues. This symbolic encoding allows users with visual impairments to group and interpret cards accurately, enabling inclusive participation without gameplay disadvantage. Unlike traditional color-based card games—physical or digital—which rely solely on visual color recognition, the invention provides an adaptable, accessible interface that supports diverse visual profiles in real time.

A further inventive step involves distinguishing suggested card groupings (e.g., potential “play” cards vs. “discard” options) using shade-based overlays rather than hue-based colors. During user testing, it became clear that color-coded overlays used to preview possible actions held no functional value for color-blind players. In response, the invention disclosed herein applies a dynamic visual treatment—such as darkening or lightening card faces—to indicate suggested playability. These adaptive shading cues are perceptible to players regardless of color perception, allowing equal cognitive access to decision-making during hand review or combination previews. This enhances strategic gameplay inclusivity and extends the accessibility engine's logic into pre-play planning, an area often overlooked in digital card interfaces. The system provides a unique technical solution to cross-device synchronization challenges by ensuring that all users interact with the same dynamically updated card state, maintained in real time with latency thresholds under five seconds. This guarantees consistent gameplay experience and eliminates data drift across clients in multi-user environments.

An additional inventive step addresses a fundamental structural limitation in existing fantasy sports systems: pre-selection of athletes from a small elite subset enables brute-force combinatorics and undermines competitive fairness. The invention disclosed herein eliminates deterministic lineup selection by requiring users to obtain athletes through real-time card gameplay. This method transforms lineup construction into a constrained, interactive process that preserves the relevance of the entire athlete pool and reduces susceptibility to collusion or outcome manipulation. By embedding this constraint into the virtual card architecture, the system provides a technical solution that shifts athlete selection from pre-event optimization to in-game decision-making—thus restoring a skill-based dynamic within large-scale digital competitions.

This invention is not about changing the fundamental gameplay structure or strategy of card games, but rather, focuses on the real-time updating of virtual card attributes using live data. The dynamic behavior of these virtual cards, such as changes in value, color, or status, allows players to interact with the evolving game environment in real-time, while still respecting the underlying structure of traditional card games.

### Summary of Features of Example Embodiments

The features of example embodiments disclosed herein encompass a computer-implemented system, method, and computer-readable medium for dynamically updating virtual card attributes based on real-time external data. The features of example embodiments include functionality for adaptive rendering based on data type, user-specific sorting, gameplay action constraints, multilingual overlays, dependency-aware logic, and protocol fallback mechanisms. The features of example embodiments further extend to accessibility features including symbolic overlays and lightness/darkness adjustments for inclusive gameplay. Together, the features of example embodiments define a scalable, modular, and accessible architecture for live data-driven digital interactions across distributed user environments.

Another feature of example embodiments is a Set-Time Bypass System that enables asynchronous advancement through tournament rounds without requiring players to be present at predesignated times. Upon achieving a qualifying finish (e.g., top 3 in a 9-player match), users receive a unique token or access code for the next round. This token grants entry to a specialized game lobby for that round, where a new game instance auto-initiates once exactly nine players with matching round access codes are present. All participants are notified at that moment, and the match begins immediately. This system eliminates disqualification due to scheduling conflicts and ensures a fair, fluid tournament experience without time-locking constraints—an architectural solution not required in traditional fantasy platforms that rely on pre-filled lineups rather than synchronous live play.

Importantly, the invention does not change any fundamental game rules or mechanics. The present invention does not implement or relate to any new rules, formats, or strategies for gameplay. Specifically, the present patent application does not seek protection for:
1. New rules for card games, fantasy sports, or competitive scoring models;
2. Methods of calculating fantasy points or ranking systems;
3. Methods of determining winners based on rules of play;
4. Any specific format of competition structure, including playoff trees, tiebreaker systems, or bracket advancement logic; and
5. Any purely abstract ideas, mathematical formulas, or business methods unrelated to technical implementation.

The invention disclosed herein is exclusively directed to a technical system that enables real-time, synchronized, and constraint-driven updates to virtual card attributes based on live external data inputs. All constraints and interactivity emerge from the architecture of the system—including the data ingestion module, card object model, rendering engine, synchronization layer, and accessibility mechanisms—not from new gameplay constructs or scoring mechanics.

Accordingly, the system's functionality does not depend on the adoption of any specific rule set and can be integrated with existing or future gameplay models without modification. This distinction ensures compliance with Article 52(2) of the European Patent Convention (EPC) by framing the invention as a technical solution to technical problems, including real-time data latency, distributed rendering consistency, accessibility for diverse users, and the prevention of deterministic, brute-force exploitation of static data systems.

The invention disclosed herein comprises a platform that dynamically modifies visual and status attributes of digital card objects based on real-time external data inputs. The system includes the following components:
1. A server-based data ingestion system configured to receive external event feeds, including but not limited to application programming interfaces (APIs) for sports, stock markets, weather, or educational metrics.
2. A programmable card object model configured to map normalized input data fields to card properties such as score, player state, color, team affiliation, a category, a value, a status, or a visual indicator, wherein the visual indicator refers to a dynamic graphical element on a virtual card that reflects a real-time attribute derived from live external data. An example is the playing status of an athlete (out, benched, on the field, injured, etc.) or the running fantasy sports total corresponding to a particular athlete. For these sample situations, visual indicators can be stamped directly on the cards.
3. A rendering engine configured to visually update card states on user interfaces with latency below five seconds, incorporating symbolic or color-based cues.
4. A synchronization layer configured to broadcast real-time updates across multiple client interfaces to ensure consistency of state and user experience.
5. An accessibility engine configured to dynamically apply visual overlays, contrast modifications, and symbolic equivalency for users with visual impairments.

The invention disclosed herein provides a flexible, real-time visualization framework that adapts to multiple industries and application domains, including but not limited to online gaming, educational platforms, stock market simulators, and weather-based interaction environments.

### Summary of Technical Effects

The invention disclosed herein achieves multiple technical effects across system architecture, data processing, and user experience domains:
Real-Time Synchronization: Ensures state consistency across distributed clients within a latency window under five seconds, eliminating gameplay drift and timing errors.
Anti-Cheating Enforcement: Embeds data-driven constraint logic into a real-time pipeline, preventing brute-force lineup generation and deterministic outcome manipulation.
Cross-Device Consistency: Supports synchronized rendering and interaction logic across mobile, web, and embedded clients using WebSocket protocols and fallback mechanisms.
Visual Accessibility: Integrates adaptive overlays and symbolic representations for color-based attributes, ensuring functional parity for users with visual impairments.
Dynamic Interaction Layer: Allows real-time modification of object attributes without introducing new game mechanics, maintaining system compatibility while enhancing interactivity.
Low-Latency Rendering: Delivers high-frequency updates using modular rendering pipelines optimized for performance, ensuring fluid gameplay and feedback loops.
Data Integrity and Compliance: Applies real-time validation and logging mechanisms for all ingested data streams, supporting auditability and GDPR-aligned processing.

### Reinforced Inventive Step—Anti-Cheating Architecture

The invention disclosed herein further introduces a non-obvious inventive step through its use of a real-time, constraint-driven interaction layer that serves as a built-in anti-cheating mechanism. By requiring users to engage in a dynamic decision-making process tied to live data streams, the platform imposes a temporal and data-based restriction on team composition that cannot be bypassed by brute-force lineup generation. This system-level enforcement eliminates a well-documented exploit in existing fantasy platforms, where users pre-select and submit thousands of deterministic combinations from a limited athlete pool to statistically cover all favorable outcomes. The present architecture makes this form of manipulation technically infeasible, as athlete assignment is governed by evolving card states that only exist in real-time and are rendered through synchronized user interface (UI) elements. No prior art addresses this combination of live-data-driven constraints, synchronized decision windows, and visual state propagation. The invention disclosed herein achieves a measurable technical effect by embedding game integrity directly into the architecture—eliminating the need for post-event auditing or manual rule enforcement. This constitutes a meaningful inventive step in the design of fair, scalable, and real-time interactive contest platforms.

### Game-Integrated Data Constraint Layer

The invention disclosed herein introduces a constraint-based architecture that synchronizes athlete assignment and decision-making with live external data streams. Unlike conventional platforms that pre-process or statically bind athlete data to user selections, this system embeds real-time data directly into the mechanics of card-based interaction. Each digital card functions not only as a visual representation but also as a real-time delivery mechanism for external event data that governs availability, score value, and state transitions. This framework enables a dynamic, rule-enforcing distribution method wherein user decisions must adapt to evolving card conditions rather than predefined strategies. By coupling athlete assignment to a synchronized card-dealing interface during live play, the system achieves a real-time, state-dependent control loop between data input, system behavior, and user interaction. This layer of architecture is critical to preserving competitive fairness, expanding the utility of all available entities (e.g., athletes), and enforcing strategic adaptation through constraint-based gameplay.
For clarity, the term “constraint-based gameplay” as used here refers to real-time system-enforced limitations that restrict or enable user actions based on the current state of dynamic, data-driven card objects. These constraints emerge from live event data and system architecture, not from newly introduced game rules or scoring strategies. The constraints function as technical enforcement mechanisms synchronized across clients, rather than abstract rules defined by player intention or designer preference.

### Tournament Progression System Without Fixed Scheduling

A further inventive step involves a Set-Time Bypass System designed to eliminate the rigid scheduling constraints common in traditional tournament structures. In conventional multiplayer contests—especially fantasy sports—players are often required to participate at predetermined times, which limits flexibility and can result in disqualification due to unavailability. To address this, the disclosed system introduces a dynamic code-based progression mechanism, whereby players who finish in the top tier (e.g., top 3 of 9) in a game round are issued a unique code or digital credential confirming their eligibility for the next round.

These players may then enter a self-paced tournament lobby restricted to similarly qualified users. Once the required number of players (typically nine) is present, the system automatically initiates the next round. All but the last entrant receive an alert (e.g., SMS or push notification) indicating the round is about to start, while the final entrant triggers the match execution via immediate visual confirmation. This implementation avoids fixed-time disqualification, ensures continuous tournament progression, and preserves fairness across asynchronous schedules. In contrast to online poker tournament structures—which still rely on scheduled start times for satellite entry and table assignments—the present system provides a fully asynchronous mechanism for tournament advancement, governed exclusively by player availability and automated matchmaking, thereby eliminating dependency on predetermined time constraints. This is implemented in an example embodiment by a tournament advancement module configured to issue advancement credentials to users who achieve qualifying scores within a multiplayer group, and a lobby matching engine configured to assign such users to a subsequent multiplayer session upon detecting a threshold number of credentialed users, thereby bypassing a fixed start time requirement for tournament rounds

No traditional fantasy sports system employs such a real-time, eligibility-gated lobby mechanism due to their dependence on fixed lineup submission windows and statically timed events. The Set-Time Bypass System enables a flexible tournament progression protocol that integrates tightly with the real-time constraint framework of the dynamic virtual card environment.

While online poker systems may also employ lobby-based game initiation, these systems do not implement a code-restricted progression model tied to prior match outcomes. In traditional online poker, users join freely accessible tables without requiring a prior achievement credential (e.g., a top-three finish in a qualifying round). Furthermore, poker satellites are scheduled at fixed times, and advancement typically hinges on point accumulation or chip count, not asynchronous qualification-based entry. By contrast, the Set-Time Bypass System disclosed herein requires players to earn entry into subsequent rounds via distinct success-based tokens and enables self-paced advancement in tightly gated environments. This differentiates the present system architecturally and functionally, and addresses scheduling flexibility in ways that existing poker implementations do not require or support.

### Latency-Controlled Synchronization Extension

To ensure consistent gameplay across distributed users, the synchronization layer maintains a latency threshold wherein card attribute updates are rendered across all connected clients within five seconds of the originating data event. This real-time propagation mechanism guarantees that all users interact with an identical card state regardless of device or location. The latency threshold serves as both a performance optimization and a fairness safeguard, eliminating the possibility of asynchronous decisions or timing-based exploits.

### Background Reinforcement: Real-World Exploits

A relevant example highlighting the structural problem in conventional fantasy sports involved an employee of a major platform who analyzed ownership percentages of athletes. By selecting undervalued star players with low selection rates, the individual assembled lineups with mathematically superior expected outcomes and won $350,000 on a competing site. Although disqualified post-contest for insider behavior, the exploit demonstrated that existing systems allow lineup manipulation purely through data access and deterministic optimization. These failures arise because current platforms lack real-time, data-synchronized constraint mechanisms to prevent such manipulation. The invention disclosed herein prevents this class of exploit not through rules enforcement, but through technical architecture that dynamically constrains athlete access and lineup formation within a live, data-bound interaction framework.

### Example Embodiment: Fantasy Sports Context

In a fantasy sports application, each card represents a live professional athlete. When the athlete scores a goal or registers a performance event, an external API transmits updated data to the system. The ingestion module receives and validates this input, then maps the data to the corresponding card's properties. The rendering engine visually reflects the update by altering the card's color, score, iconography, or status markers. The rendering engine dynamically renders updated attributes—such as card color, score, iconography, or status markers—ensuring visual consistency across synchronized interfaces. The synchronization layer ensures the changes appear in near real-time across all participating client devices. Users may receive visual or haptic feedback in response to key events. This embodiment illustrates real-time, scalable data-driven interaction in an environment where latency and feedback are critical to user experience.

### Alternative Use Cases

The system is architecturally neutral and supports diverse use cases beyond fantasy sports:
1. Meteorological applications can use dynamically updating cards to display temperature, wind speed, or precipitation levels for different geographic regions.
2. Financial simulations can assign cards to equities or indices, with attributes reflecting price fluctuations, volume, or volatility.
3. Educational platforms can deploy cards that reflect current global metrics, news events, or student performance data in real time.
4. Political simulation games can assign virtual cards to political candidates, debate topics, or policy positions. As real-time polling data, public sentiment, or live debate interactions unfold, these cards dynamically change in status, support levels, or rhetorical strength. Users engage in card-based strategy games where political positions gain or lose traction during real-world political events, such as debates or elections.

### Concrete Example Implementation

The system of an example embodiment may be implemented using a web-based front-end developed in React, with WebSocket for full-duplex real-time communication. The backend may consist of a Node.js server processing external data feeds and mapping them to a normalized data schema stored in MongoDB or PostgreSQL. The rendering engine may utilize WebGL to ensure high performance updates. Accessibility overlays may be computed dynamically using user-specific configurations. Security and failover are managed via encrypted channels and HTTP polling fallback mechanisms. Audit trails and data validation logs are stored in an append-only structure compliant with GDPR Article 30.

### GDPR and Compliance Statement

To align with the European Union's General Data Protection Regulation (GDPR), the system is designed with multiple compliance layers. These include consent-based data access, data minimization strategies, and structured logging of all data ingestion events. Personal data, if present, is pseudonymized prior to processing, and retention policies are enforced based on configurable time thresholds. Audit trails are stored in an append-only, access-restricted log compliant with Article 30 of the GDPR. The platform architecture allows for data subject access requests (DSARs) and includes tooling for data erasure and export in standardized formats. These safeguards apply across all system modules involved in real-time data handling, card rendering, user preference storage, and multiplayer synchronization. By embedding these compliance measures directly into the system architecture, the invention ensures that legal obligations are met without compromising real-time responsiveness or user experience.

### Real-Time Constraint Enforcement Pipeline

To prevent deterministic lineup manipulation and brute-force athlete selection, the system integrates a constraint enforcement pipeline that operates across the ingestion, rendering, and interaction layers. When external performance data is ingested (e.g., an athlete scores or changes status), the system immediately updates associated card attributes and re-evaluates the permissible actions for users currently viewing or interacting with those cards. These updates are processed through a rules engine that dynamically recalculates the availability or lock status of cards, preventing unauthorized changes or delayed reactions that could give an advantage to automation-based strategies. The updated rule states are then pushed via the synchronization layer to all active clients, ensuring that users receive a consistent, real-time enforcement signal. This pipeline enforces temporal constraints tied to the state of live data, meaning user decisions are made within tightly bounded windows where card states are in flux. Because athlete availability is governed by evolving card logic rather than static lists or pre-event selection, the system renders brute-force enumeration of athlete lineups infeasible. This constraint mechanism is not a gameplay rule but a software-level synchronization framework that enforces fair participation using real-time system behavior.

### Flow Diagram of Data Pipeline

The system's data pipeline of an example embodiment proceeds as follows:
External APIs push live data into the ingestion module.
A normalization and validation layer ensures consistent schema adherence.
Validated data is mapped to programmable card object instances.
The rendering engine transforms mapped attributes into visual elements.
A synchronization layer propagates visual changes to active client sessions.
An accessibility engine applies visual overlays and symbolic modifications in real time based on user preference or system settings.

### Adaptive Rendering by Data Type

The rendering engine of an example embodiment includes an adaptive logic module that evaluates the structure of each incoming data field associated with a card attribute. This module identifies whether the data is numeric, categorical, ordinal, or time-series and applies a corresponding rendering strategy. For instance, numeric fields such as live scores are formatted with precision thresholds and scaling rules; categorical fields like player status are mapped to symbolic overlays; time-series inputs may invoke animated indicators or delta bars. This allows the same rendering pipeline to accommodate heterogeneous data formats while maintaining performance and consistency. Rendering templates are updated dynamically based on the attribute type and user profile settings. The rendering engine employs a templating library that can assign distinct visual treatment to score-based metrics, threshold-triggered events, or class-based identifiers in real time.

### Gameplay Action Constraints Engine

The system of an example embodiment includes a rules-based gameplay engine that dynamically updates the set of permissible player actions based on real-time changes to card attributes. Each card object is linked to a decision matrix that defines valid moves, availability status, or interaction permissions. When live data alters a card's value, such as a player's injury status or performance threshold, the engine recalculates constraints and broadcasts the updated rule set to all client interfaces. This ensures that the current state of each card governs which options are available to users during gameplay, enabling a responsive and strategically coherent experience. The constraints are enforced by both the UI layer and the server logic, ensuring consistency across multi-user environments.

### Multilingual Overlay Management

To support accessibility and global usability, the system of an example embodiment incorporates a multilingual overlay service that dynamically renders card text, labels, and symbolic cues in the user's preferred language. Language settings are stored per user session and applied during card rendering using an internationalization (il8n) library integrated with the frontend. The service supports left-to-right and right-to-left layouts, Unicode-compliant fonts, and locale-specific symbol variations. Updates to athlete names, categories, or status descriptions are automatically passed through a translation layer before rendering. For symbolic overlays, alternate icons are selected based on regional conventions. This capability ensures inclusivity across diverse user bases and compliance with localization best practices, supporting a scalable deployment strategy.

### Profile-Based Card Sorting Engine

The platform includes a real-time sorting engine that leverages persistent user profiles to reorder card displays according to individual preferences. Sorting parameters include role (e.g., offensive vs. defensive), performance ranking, team affiliation, and custom tags defined by the user. Each profile is synced with a user's account and cached locally to reduce latency. When live data modifies a relevant attribute (such as a new score or player status), the engine re-evaluates the sort order and re-renders the card layout accordingly. The system supports multi-criteria prioritization and exposes a preference management interface via the client UI. The result is a dynamically tailored card view that reflects both real-time data and individualized strategy contexts.

### Inter-Card Dependency Graph System

The system of an example embodiment incorporates a dependency graph model that maps logical or statistical relationships between card objects. Each card may declare one or more directional links to other cards based on shared attributes, team membership, positional relevance, or historic correlation. When a triggering event updates the source card, such as a change in status or score, the dependency engine evaluates linked targets and applies updates according to predefined rules. These rules can be deterministic (e.g., update all linked cards' icons when a team captain card changes state) or probabilistic (e.g., apply performance boosts based on correlated metrics). Dependency definitions are stored in a graph schema and optimized for traversal efficiency, ensuring real-time propagation with minimal performance overhead. This feature supports deeper strategic gameplay and enables compound visualization logic.

### System Overview

The system of an example embodiment operates as a modular data visualization and interaction platform. The system ingests real-time data from external sources, maps this data to programmable card attributes, and dynamically renders visual elements for display across synchronized user interfaces. A rendering engine updates card states with minimal latency, while a synchronization layer ensures consistency across all connected clients. Accessibility features and user profile preferences are integrated throughout the pipeline to support broad usability across environments and device types.

### Client-Server Architecture Distinction

The system of an example embodiment is logically divided into client-side and server-side components to maximize performance and architectural clarity. The server-side includes the data ingestion module, normalization layer, constraint enforcement engine, and the backend synchronization layer—responsible for capturing external live data, validating and transforming it, enforcing gameplay constraints, and propagating consistent updates. The client-side includes the rendering engine, accessibility overlay system, multilingual UI layer, and interaction logic. These client modules are responsible for displaying card updates in real time, enabling responsive user interactions, and adjusting visuals dynamically based on user profiles and device capabilities. This distributed architecture enables device-independent deployment while ensuring technical effects such as latency reduction, accessibility, and fair gameplay enforcement are achieved through collaborative, layered processing.

### Technical Definitions

Card Object: A digital object rendered on-screen with properties including value, status, color, metadata, and iconography.
Rendering Engine: The software module that translates card object properties into graphical representations.
WebSocket: A bi-directional communication protocol for real-time data transfer.
Accessibility Overlay: A visual enhancement that adjusts card appearance for users with visual impairments, including symbolic replacements for color.
Synchronization Layer: A module responsible for broadcasting attribute changes to client interfaces in real time.
Dependency-Aware Rendering: Logic allowing updates to one card to trigger changes in related cards.
Normalization Layer: Middleware that translates incoming external data formats into a standardized internal schema.
Latency Threshold: The maximum allowable delay between receipt of new data and update of visual state, targeted under five seconds.
Constraint Enforcement Engine: A software module that dynamically governs user actions during gameplay based on real-time updates to card attributes. It evaluates external event data, applies state-based constraints, and synchronizes permissible decisions across all client interfaces, ensuring fairness and preventing deterministic lineup manipulation.

### Technical Term Reference

The following system components are referenced throughout the claims and technical description:
Card object model: A structured digital object representing an individual unit (e.g., athlete, entity) with mapped data attributes.
Rendering engine: The module responsible for transforming mapped card data into a visual UI representation.
Synchronization layer: A backend service that ensures consistent real-time state across all connected client interfaces.
Data ingestion module: A service layer that captures and normalizes external data feeds.
Accessibility engine: A UI component that adapts visual output to meet accessibility standards and user preferences.
WebSocket/fallback protocol: The real-time communication stack with retry and polling support.
Symbolic overlays: Visual iconography used to augment or substitute color-based cues.
User preference system: A profile-linked configuration engine that adjusts rendering and sorting behavior.
Dependency-aware logic: The system's rule-based relationships that link card states together.
Configuration profiles: Stored user or system presets used to determine visual behavior and performance settings.
Normalization layer: Middleware that converts heterogeneous external data formats into a unified schema.

### Description of an Example Embodiment

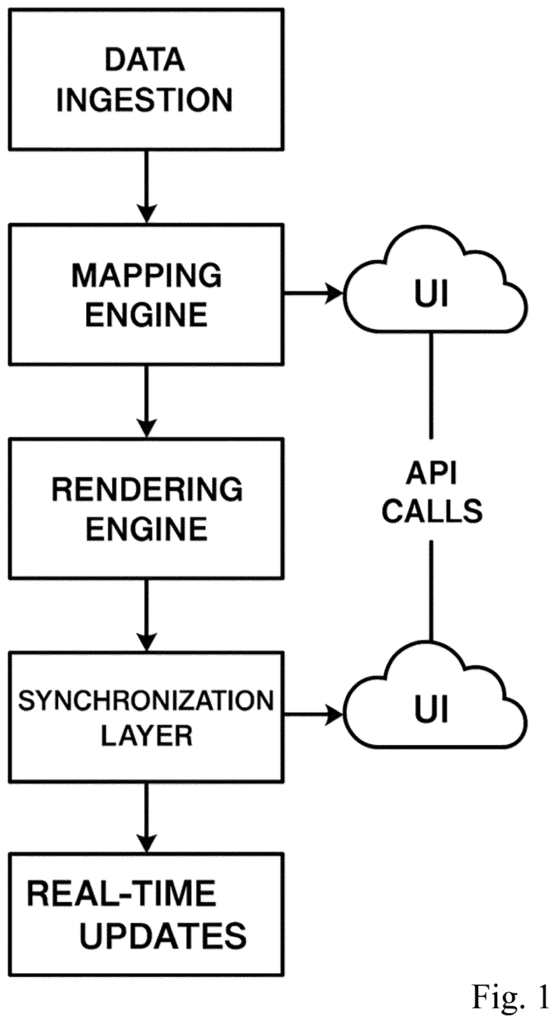

FIG. 1 illustrates the core system architecture of an example embodiment. The diagram shows a sequential pipeline comprising the Data Ingestion module, Mapping Engine, Rendering Engine, Synchronization Layer, and the final Real-Time Updates output. The system connects to user interfaces (UIs) via API calls at multiple points for display and interactivity. FIG. 1 is a block diagram showing a system architecture of an example embodiment, including ingestion, backend, and rendering. The diagram represents the modular system and real-time updates flow. This figure supports claims related to modular architecture and multi-client update propagation.

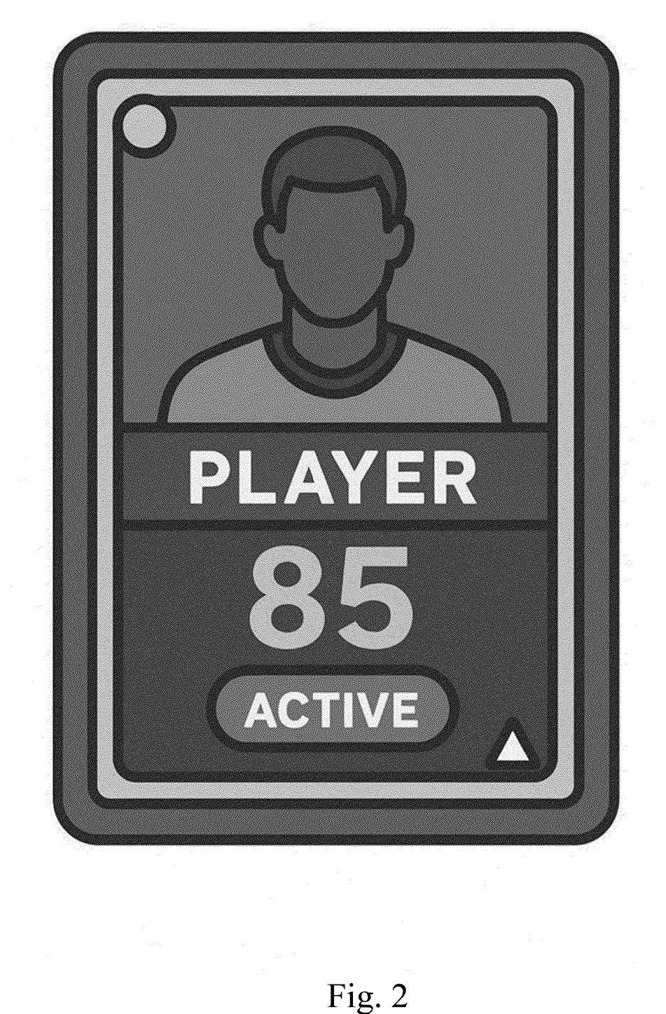

FIG. 2 shows a sample card object design of an example embodiment used within the user interface. The card visually encodes a player's name, score (here: 85), and status (“ACTIVE”). The layout demonstrates how key metrics are rendered in real time as attributes change. The layout visualizes real-time updates and interactions. This figure supports claims around visual annotation, symbolic overlays, and user interaction.

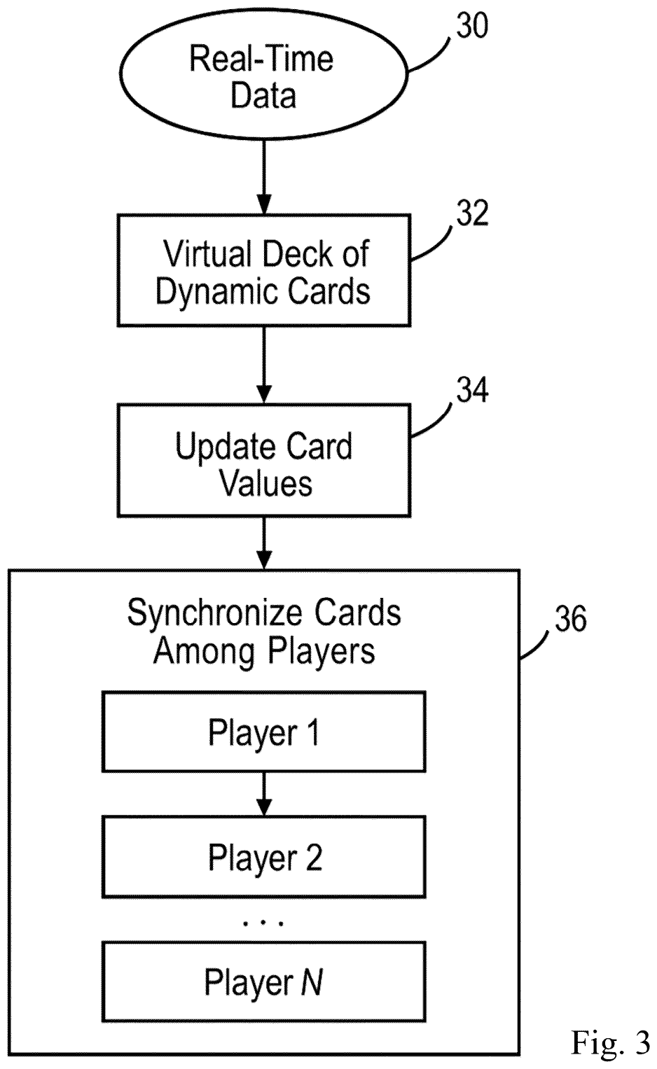

FIG. 3 illustrates the flow of real-time data 30 into a virtual deck of dynamic cards 32. The diagram shows real-time data synchronization across multiple users 36, and illustrates how updates to athlete data 34 propagate through the ingestion, rendering, and gameplay constraint layers. This supports claims related to multi-client synchronization, real-time fairness enforcement, and constraint-driven card availability. The figure highlights the dynamic link between data input and user-visible card states, which underpins the system's ability to prevent deterministic pre-selection strategies and brute-force lineup optimization. It includes steps for updating card values and synchronizing those updates across players (Player 1 through Player N). This supports claims regarding card synchronization and data-driven state management.

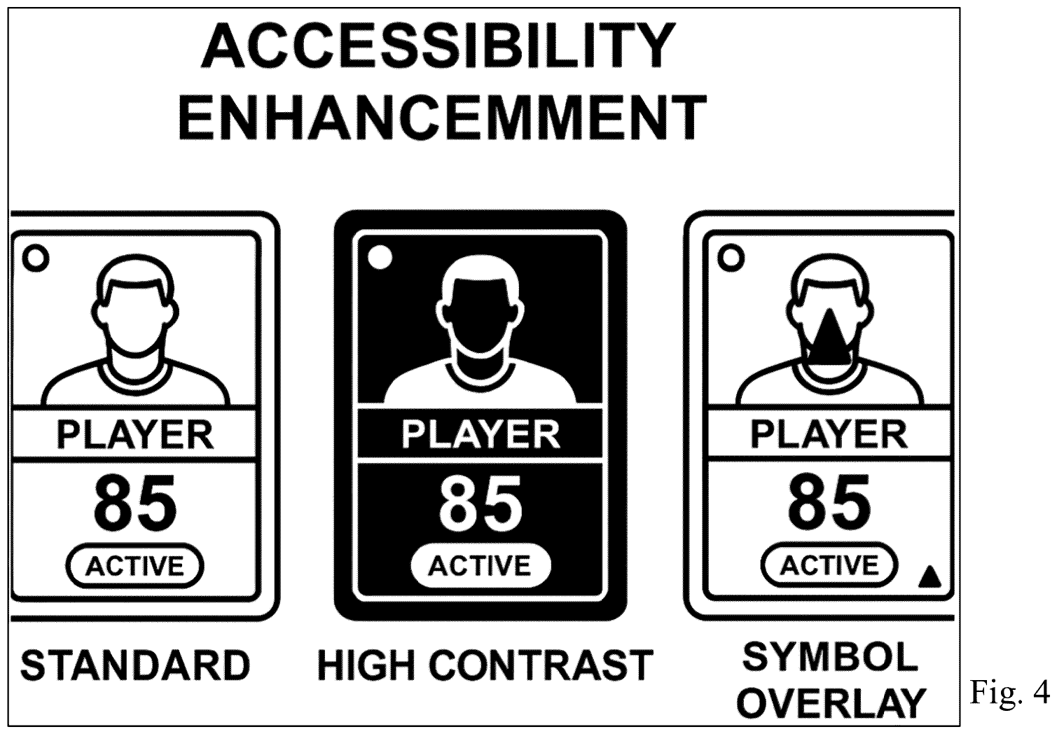

FIG. 4 presents three accessibility-enhanced card views: a standard version, a high-contrast mode, and one with symbolic overlays for accessibility. These variations demonstrate inclusive design for users with visual impairments. This directly supports claims related to accessibility overlays and symbolic encoding.

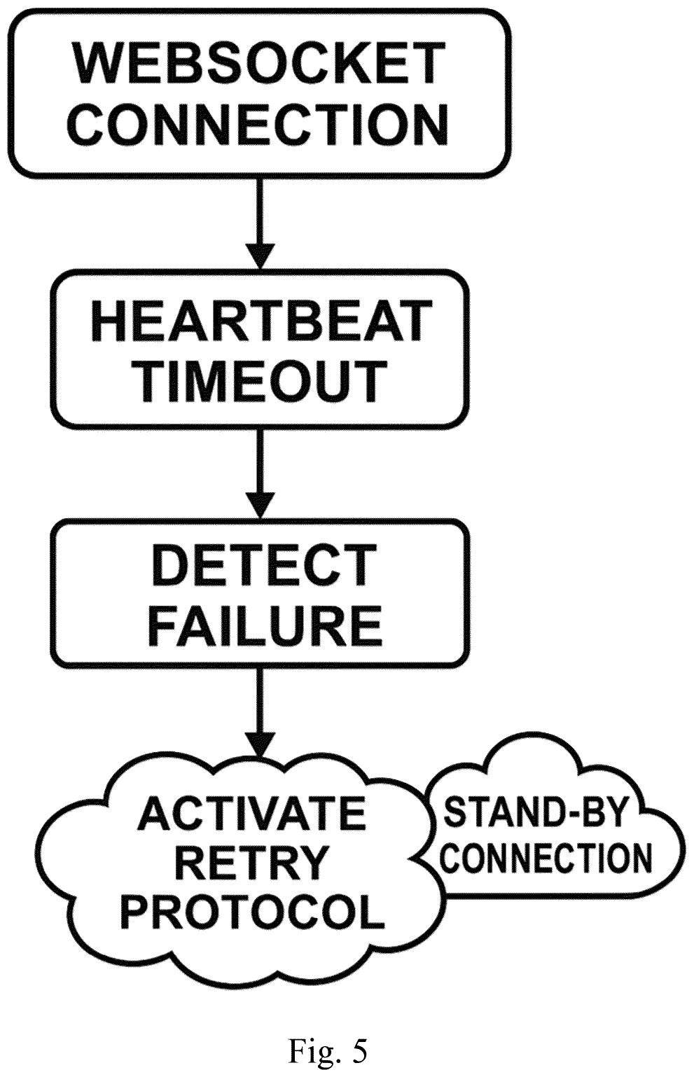

FIG. 5 shows a WebSocket failover protocol. When a connection fails due to a heartbeat timeout, the system detects the failure and triggers a retry using a standby connection. This diagram supports claims concerning real-time communication protocols and fault tolerance.

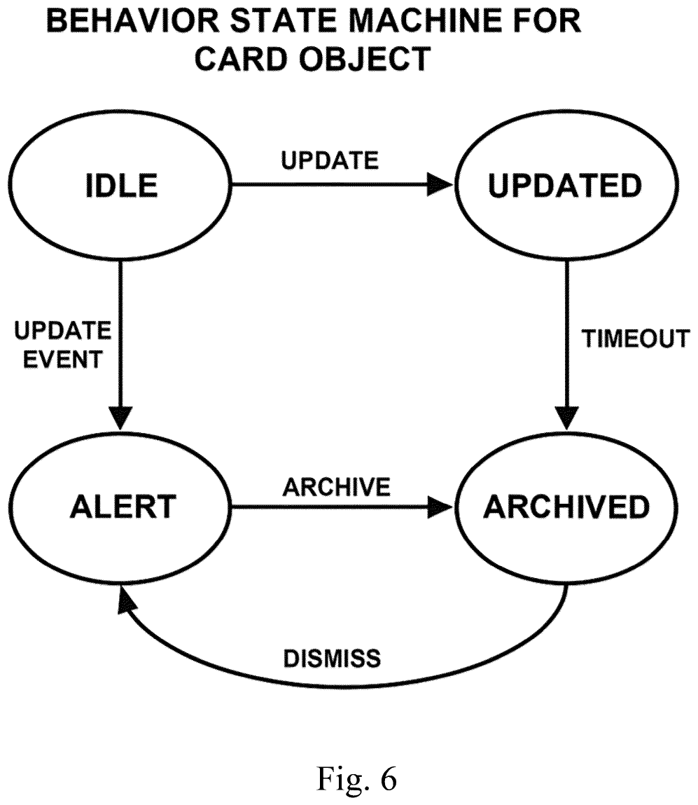

FIG. 6 is a behavior state machine for card objects. It depicts four states (IDLE, UPDATED, ALERT, ARCHIVED) and the transitions between them, such as timeout, archive, update event, and dismiss. This supports claims involving dynamic status changes and event-driven behavior models.

### Claimable Embodiments

A computer-implemented system for managing a dynamic virtual card deck, comprising:
a data ingestion module configured to receive live data feeds from an external source;
a card object model configured to map data fields to card attributes including point value, color, and player status;
a rendering engine configured to display cards dynamically on user devices;
a synchronization layer configured to propagate updates in real time to distributed clients.

The system claimed above, wherein data feeds originate from APIs corresponding to live sporting events.

The system claimed above, wherein attribute updates are rendered within a latency threshold of five seconds.

The system claimed above, wherein the rendering engine visually annotates cards to indicate real-time metrics or milestone achievements.

The system claimed above, wherein the card object model allows grouping of cards into teams or other logical units.

A computer-implemented method for real-time management of virtual card attributes, comprising:
receiving live data inputs from an external source;
updating card object properties based on mapped attributes;
rendering the updated cards in a user interface;
enabling user interaction with the updated cards.

The method claimed above, wherein card objects represent real-world entities whose states reflect corresponding external data.

A non-transitory computer-readable medium comprising instructions that, when executed by a processor, perform the method claimed above.

The system claimed above, further comprising an accessibility engine providing contrast overlays or symbolic representations for improved visual legibility.

The system claimed above, wherein symbolic overlays encode category equivalence in lieu of color-based differentiation.

The system claimed above, wherein player status includes states such as “active,” “benched,” “injured,” “suspended,” or “eliminated.”

The system claimed above, wherein card color reflects team-based or aggregate performance metrics.

The method claimed above, further comprising notifying users upon attribute changes triggering a state transition.

The system claimed above, wherein each card includes metadata for data source and last update timestamp.

A method for dynamically ranking virtual cards in real time based on user-defined criteria, including performance variation.

The system claimed above, wherein the rendering engine applies visual animations or haptic feedback based on predefined trigger thresholds.

The method claimed above, wherein user interfaces permit card sorting based on live values such as status, score, or category.

The medium claimed above, wherein instructions include fallback protocols to polling in the event of WebSocket failure.

The system claimed above, wherein each card object may trigger updates in related cards through dependency-aware logic.

The system claimed above, wherein accessibility overlays include lightness or darkness adjustments dynamically computed relative to default brightness.

The system claimed above, wherein update propagation is facilitated via a real-time protocol such as WebSocket.

The system claimed above, wherein failure of the real-time channel activates a retry or fallback protocol.

The system claimed above, wherein input data undergoes real-time integrity checks before attribute mapping.

The system claimed above, wherein the architecture enables device-independent deployment across heterogeneous platforms.

The system claimed above, wherein rendering layers support modular optimization for resource-limited environments.

The system claimed above, wherein the rendering engine includes logic to support visual overlays that highlight cards crossing predefined performance thresholds.

The system claimed above, wherein the contrast-based accessibility mode supports both static and interactive pre-selection overlays.

The system claimed above, wherein the system logs each data update transaction in an append-only record, including timestamp, data origin, and change classification.

The system claimed above, wherein the data ingestion module includes a normalization layer to support schema abstraction across different external data sources.

The system claimed above, wherein the rendering engine supports configuration profiles for display format preferences such as animation frequency, contrast level, or symbol set selection.

The system claimed above, wherein the rendering engine dynamically adjusts the visual format of card attributes based on the type of data ingested (e.g., numeric, categorical, time-series).

The method claimed above, wherein permissible player actions during gameplay are dynamically constrained or expanded based on the real-time state of one or more card attributes.

The system claimed above, wherein the accessibility engine includes language-specific symbolic overlays or card metadata for multilingual users.

The method claimed above, wherein the card sorting mechanism applies user-specific profiles to prioritize cards based on role, category, or current performance thresholds.

The system claimed above, wherein an update to one card triggers a probabilistic or rule-based update in related cards, based on predefined dependency mappings.

A computer-implemented system for real-time enforcement of data-driven constraints in multiplayer fantasy sports, comprising:
a data ingestion module configured to receive external event data;
a real-time constraint enforcement engine configured to map event data to user-specific action permissions, thereby preventing pre-event lineup construction or deterministic optimization;
a rendering module configured to visually update card-based objects based on current constraints;
a synchronization layer configured to propagate action eligibility updates across distributed user interfaces within a predefined latency window.

The system claimed above, wherein user-facing card content is rendered using a multilingual overlay engine adapted to session-specific language preferences.

The system claimed above, wherein the constraint enforcement engine disables selection of virtual card objects based on a detected data update timestamp exceeding a predefined eligibility window.

A non-transitory machine-useable storage medium embodying instructions which, when executed by a machine, cause the machine to:
receive, via a network interface, live external event data;
normalize the received data to a predefined schema and map the normalized data to corresponding attributes of each of a plurality of virtual card objects stored in memory, the attributes including at least a value, a status, and a visual indicator;
within a latency threshold of five seconds or less, render updated graphical representations of the virtual card objects in a user interface based on the updated attributes;
broadcast the updated graphical representations, through a synchronization layer, to a plurality of remote client devices so that all client devices display a uniform state of the virtual card objects; and
recalculate, by a rules-based constraint engine, a set of user actions permissible with respect to the updated virtual card objects based on the updated attributes, and enforce the recalculated set of permissible user actions until a subsequent update, thereby enabling user interaction with the updated virtual card objects only within the recalculated permissible actions.

### Interpretation Guidance

The description provided herein is intended for illustrative purposes. Variants and enhancements based on this disclosure will be apparent to those skilled in the art. The claims are to be interpreted in the broadest reasonable manner in line with U.S. and European patent law, especially in the context of software systems providing technical effects.

Claims are to be interpreted to encompass system-level enforcement of gameplay fairness via real-time state-bound interaction constraints. These constraints are implemented not as game rules, but as architectural features that limit lineup manipulation and support equitable distribution of live-action data in multiplayer settings.

### Definition of Acronyms

Acronyms used herein are defined as follows:
JSON: JavaScript Object Notation
API: Application Programming Interface
UI: User Interface
WebGL: Web Graphics Library

### Technical Field Classifications

Classification codes related to the described embodiments are as follows:

| Classification Code | Description |
|---|---|
| G06F 3/0484 | Graphical user interface aspects of data display |
| G06F 3/0481 | Real-time visual representation systems |
| A63F 13/218 | Electronic adaptations of card games |
| G06Q 50/00 | Data processing for specific industries |

### Administrative Note

For streamlined examination, the disclosure herein may include sequential numbering for all paragraphs and illustrations to assist with cross-referencing during U.S. and European Patent Office (EPO) prosecution. The claims have been structured in accordance with U.S. and EPO guidelines, including a primary independent system claim and supporting dependent claims categorized by technical function. Each figure presented corresponds to one or more technical concepts claimed herein and has been mapped accordingly. The applicant acknowledges that modular or grouped examination of related claims is acceptable and welcomes any examiner feedback on preferred structuring for prosecution efficiency.

Additionally, the applicant has mapped claim language and figure references to the constraint-enforcing mechanisms that prevent deterministic lineup abuse. These mechanisms are implemented as dynamic, system-level synchronization and action-restriction components, not mere gameplay features, and should be treated as such during examination under Articles 52 and 56 EPC.

To support proper interpretation under EPC Article 52, the applicant respectfully requests that the examiner consider the invention in the context of its applicability to non-gaming domains—including but not limited to finance, meteorology, education, and political simulations. The claimed technical architecture is designed to support any distributed data environment where dynamic object rendering, latency-sensitive updates, and multi-client synchronization are necessary, irrespective of game rules or entertainment objectives.

What is claimed is:

1. A computer-implemented system for managing a dynamic virtual card deck, comprising:
a data ingestion module configured to receive live data feeds from an external source;
a card object model configured to map data fields to card attributes including point value, color, and player status;
a rendering engine configured to display cards dynamically on user devices; and
a synchronization layer configured to propagate updates in real time to distributed clients.

2. The system of claim 1, wherein data feeds originate from application programming interfaces (APIs) corresponding to live sporting events.

3. The system of claim 1, wherein attribute updates are rendered within a latency threshold of five seconds or less.

4. The system of claim 1, wherein the rendering engine visually annotates cards to indicate real-time metrics or milestone achievements.

5. The system of claim 1, wherein the card object model allows grouping of cards into teams or other logical units.

6. The system of claim 1, further comprising an accessibility engine providing contrast overlays or symbolic representations for improved visual legibility.

7. The system of claim 1, further comprising symbolic overlays encoding category equivalence in lieu of color-based differentiation.

8. The system of claim 1, wherein player status includes states of, active, benched, injured, suspended, or eliminated.

9. The system of claim 1, wherein card color reflects team-based or aggregate performance metrics.

10. The system of claim 1, wherein each card includes metadata for a data source and a last update timestamp.

11. The system of claim 1, wherein the rendering engine applies visual animations or haptic feedback based on predefined trigger thresholds.

12. The system of claim 1, wherein each card object may trigger updates in related cards through dependency-aware logic.

13. The system of claim 1, wherein accessibility overlays include lightness or darkness adjustments dynamically computed relative to default brightness.

14. The system of claim 1, further comprising a tournament advancement module configured to issue advancement credentials to users who achieve qualifying scores within a multiplayer group, and a lobby matching engine configured to assign such users to a subsequent multiplayer session upon detecting a threshold number of credentialed users, thereby bypassing a fixed start time requirement for tournament rounds.

15. A computer-implemented method for real-time management of virtual card attributes, comprising:
receiving live data inputs from an external source;
updating card object properties based on mapped attributes;
rendering the updated cards in a user interface; and
enabling user interaction with the updated cards.

16. The method of claim 15, wherein card objects represent real-world entities whose states reflect corresponding external data.

17. The method of claim 15, further comprising notifying users upon attribute changes triggering a state transition.

18. A method of claim 15, further comprising dynamically ranking virtual cards in real time based on user-defined criteria, including performance variation.

19. The method of claim 15, wherein user interfaces permit card sorting based on live values such as status, score, or category.

20. A non-transitory machine-useable storage medium embodying instructions which, when executed by a machine, cause the machine to:
receive, via a network interface, live external event data;
normalize the received data to a predefined schema and map the normalized data to corresponding attributes of each of a plurality of virtual card objects stored in memory, the attributes including at least a value, a status, and a visual indicator;
within a latency threshold of five seconds or less, render updated graphical representations of the virtual card objects in a user interface based on the updated attributes;
broadcast the updated graphical representations, through a synchronization layer, to a plurality of remote client devices so that all client devices display a uniform state of the virtual card objects; and
recalculate, by a rules-based constraint engine, a set of user actions permissible with respect to the updated virtual card objects based on the updated attributes, and enforce the recalculated set of permissible user actions until a subsequent update, thereby enabling user interaction with the updated virtual card objects only within the recalculated permissible actions.

21. The medium of claim 20, wherein the instructions include fallback protocols to polling in the event of WebSocket failure.
